(19) United States
(12) Patent Application Publication
(10) Pub. No.: US 2008/0158423 A1
(43) Pub. Date: Jul. 3, 2008

(54) DIGITAL BROADCASTING APPARATUS AND METHOD FOR PROCESSING KEY SIGNAL

(75) Inventor: Doo-hee Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/761,650

(22) Filed: Jun. 12, 2007

(30) Foreign Application Priority Data
Dec. 29, 2006 (KR) 2006-138123

(51) Int. Cl. H04N 5/45; G06F 3/048

(52) U.S. Cl. 348/565; 715/788; 348/E05.112

(57) ABSTRACT

A digital broadcasting apparatus and a method for processing a key signal are provided. The apparatus includes a display part which displays application programs being received from a plurality of tuned channels on a main screen and a plurality of sub-screens; a signal receiver which receives a key signal requesting a specific function; a determiner which determines a target screen from among the main screen and the plurality of sub-screens, when the key signal is received; and a function module which applies a specific function corresponding to the received key signal to the determined target screen.

### CROSS-REFERENCE TO RELATED APPLICATIONS

This application claims priority under 35 U.S.C. §119 from Korean Patent Application No. 10-2006-0138123, filed on Dec. 29, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to processing a key signal, and more particularly, to processing a key signal so that a process corresponding to a key manipulation can be suitably performed when displaying different Xlets using a picture-in-picture (PIP) function.

2. Description of the Related Art

As a result of the development of digital technologies, users tend to prefer interactive services over unidirectional services in TV services. In other words, digital broadcasting apparatuses provide interactive services including receiving streams transmitted from broadcasting stations, processing the streams, and transmitting user's intention to broadcasting stations.

Broadcasting stations provide various types of Xlets to digital broadcasting apparatuses by interactive services and execute the provided Xlets. Xlets can be programs, such as games provided from broadcasting stations, electronic program guide (EPG) information, and weather information. In order to execute Xlets, a user may manipulate function keys included in digital broadcasting apparatuses.

If a digital broadcasting apparatus provides a picture-in-picture (PIP) function, the apparatus may simultaneously display programs provided on different channels on a screen by the PIP function. For example, a digital broadcasting apparatus displays a broadcast program of a routine channel on a main screen, and displays an Xlet on a sub-screen. A user controls the PIP function using a user interface, such as a remote controller. In other words, if the function key manipulated by the user is a key defined in a specification for interactive services, the digital broadcasting apparatus may control the Xlet on the sub-screen. If the function key is a key which is not defined in the specification, the digital broadcasting apparatus may control the broadcast program on the main screen.

However, in a related art digital broadcasting apparatus, there is no method for processing operations related to the user's key manipulation when displaying two Xlets using the PIP function. Accordingly, if a function key is selected when different Xlets are displayed on the main screen and sub-screen, the related art digital broadcasting apparatus is unable to determine to which one of the Xlets the selected function key is applied.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a digital broadcasting apparatus and a method for processing a key signal so that a process corresponding to a key manipulation can be suitably performed when displaying different Xlets using a picture-in-picture (PIP) function.

According to an aspect of the present invention, there is provided a digital broadcasting apparatus for processing a key signal, the apparatus comprising a display part which displays application programs being received from a plurality of tuned channels on a main screen and a plurality of sub-screens; a signal receiver which receives a key signal requesting a specific function; a determiner which determines a target screen from among the main screen and the plurality of sub-screens, if the key signal is received; and a function module which applies a specific function corresponding to the received key signal to the determined target screen.

The function module may comprise a graphical user interface (GUI) generator which generates a GUI for setting the target screen. The GUI generator may generate the GUI and the display part may display the generated GUI, if a display of the GUI is requested via the signal receiver.

The apparatus may further comprise a storage part which stores identification information of the target screen set through the GUI, and the determiner may check the identification information stored in the storage part to determine the target screen. The target screen may be changed.

The apparatus may further comprise a monitor application part which determines whether or not the received key signal is a first signal for controlling one of the application programs, if the key signal is received. The determiner may determine the target screen currently being focused, upon determination that the received key signal is the first signal.

The apparatus may further comprise a monitor application part which determines, if the key signal is received, whether or not the received key signal is a second signal for controlling a native program which is a non-application program. The function module may apply a specific function corresponding to the received key signal to the native program, upon determination that the received key signal is the second signal.

The application programs may be implemented in the Java programming language.

The application programs may comprise an Xlet executed by a Java Application Programming Interface (API) defined in the Advanced Common Application Platform (ACAP) standard or Open Cable Application Platform (OCAP) standard.

According to another aspect of the present invention, there is provided a method for processing a key signal in a digital broadcasting apparatus, the method comprising displaying application programs being received from a plurality of tuned channels on a main screen and a plurality of sub-screens; receiving a key signal requesting a specific function; determining a target screen from among the main screen and the plurality of sub-screens; and applying a specific function corresponding to the received key signal to the determined target screen.

The method may further comprise generating and displaying a graphical user interface (GUI) if a display of the GUI for setting the target screen is requested; and storing identification information of the target screen set through the GUI. The determining may comprise checking the stored identification information to determine the target screen.

The method may further comprise determining whether or not the received key signal is a first signal for controlling one of the application programs, if the key signal is received, and the determining may comprise determining the target screen currently being focused, upon determination that the received key signal is the first signal.

The method may further comprise determining, if the key signal is received, whether or not the received key signal is a second signal for controlling a native program which is a non-application program; and applying a specific function corresponding to the received key signal to the native program, upon determination that the received key signal is the second signal.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a schematic view illustrating a digital broadcasting apparatus for processing a key signal, according to an exemplary embodiment of the present invention;

FIG. 2 is an exemplary view illustrating a graphical user interface (GUI) which is generated by a GUI generator of FIG. 1 in order to set a target screen, according to an exemplary embodiment of the present invention; and

FIG. 3 is a flowchart explaining a method for processing a key signal in the digital broadcasting apparatus shown in FIG. 1 according to an exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

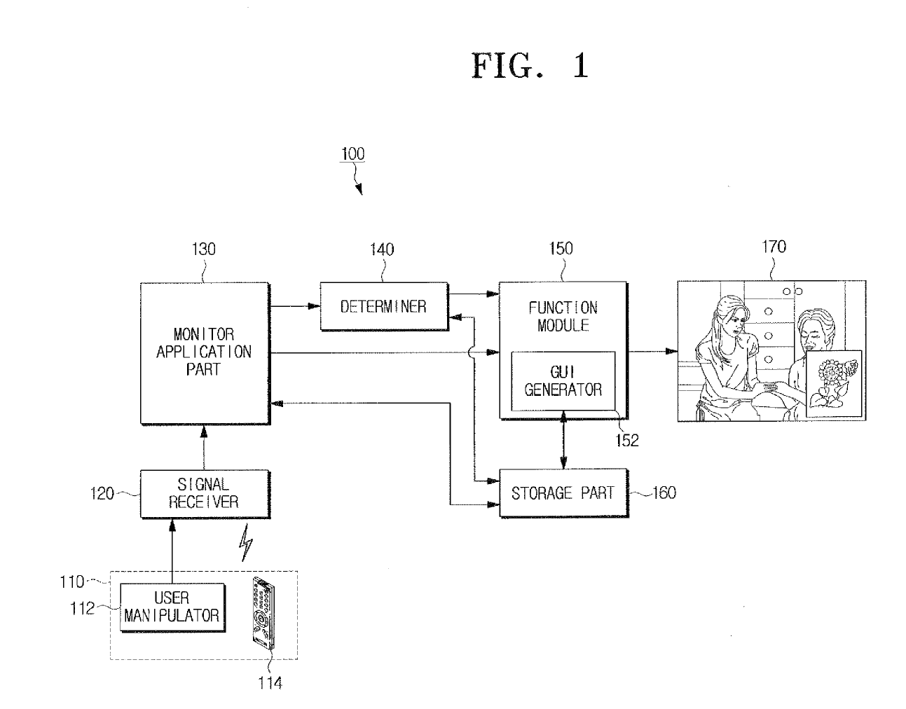

FIG. 1 is a schematic view illustrating a digital broadcasting apparatus for processing a key signal, according to an exemplary embodiment of the present invention.

As shown in FIG. 1, a digital broadcasting apparatus 100 provides interactive services based on the Advanced Common Application Platform (ACAP) standard or Open Cable Application Platform (OCAP) standard. The interactive services are provided by a head end (not illustrated), such as a broadcasting station, and the set standards. The ACAP standard makes it possible to receive a broadcasting signal or data through a public broadcasting system, and transmit the data to a service provider through a cable, such as a local area network (LAN). The OCAP standard makes it possible to transmit and receive a broadcast signal and data through a single communication channel, such as a cable.

The digital broadcasting apparatus 100 receives an application program including a game from the head end using an Application Program Interface (API) defined in the above standards, and executes the received API to provide the application program to a user.

The API means a collection of functions provided for the application program. The API may be implemented in the Java programming language, but is not limited to the Java programming language. The application program provides a game provided from the head end, weather information and stock information, and includes, for example, an Xlet which is implemented by a Java API defined in one of the ACAP and OCAP standards.

The digital broadcasting apparatus 100 basically supports a picture-in-picture (PIP) function. The PIP function makes it possible to simultaneously tune to at least two channels, and display different broadcast programs on a display part 170. A plurality of programs may be displayed on a main screen and a plurality of sub-screens. Recently, the digital broadcasting apparatus 100 receives a plurality of application programs, that is, a plurality of Xlets to be displayed using the PIP function, in addition to the broadcast programs. In other words, the digital broadcasting apparatus 100 may display application programs (hereinafter, referred to as “Xlet”) being received from the plurality of the tuned channels on the main screen and the plurality of sub-screens.

Accordingly, the digital broadcasting apparatus 100 comprises a user interface part 110, a signal receiver 120, a monitor application part 130, a determiner 140, a function module 150, a storage part 160, and a display part 170.

The user interface part 110 is used as a user interface which outputs a key signal which enables a user to request, set, or change a specific function supported by the digital broadcasting apparatus 100. The user interface part 110 comprises several buttons, number keys, direction keys, function keys, shortcut keys or other keys.

If the digital broadcasting apparatus 100 displays two Xlets for one or more games using the PIP function, a user may manipulate the user interface part 110 to request a specific function (for example, transport in a transport direction, movement, or the like) related to the game. The user interface part 110 may include separate function keys for the Xlet.

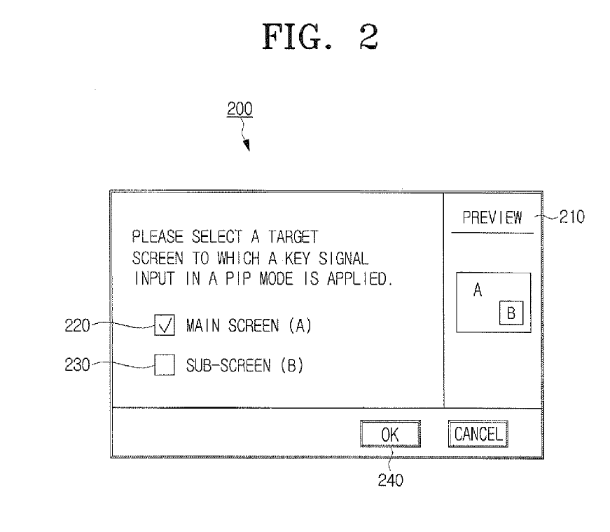

Additionally, the user may manipulate the user interface part 110 to request a display of a graphical user interface (GUI), as shown in FIG. 2. The user may set and change a target screen using the displayed GUI. If the plurality of Xlets are displayed on the main screen and the plurality of sub-screens in a PIP mode, the target screen may be a screen which is set so that a key signal input through a user manipulator 112 may be applied to the main screen and the plurality of sub-screens.

Hereinafter, an exemplary description will be given of a situation in which different Xlets are displayed on a single main screen A and a single sub-screen B in the PIP mode through the main screen A and sub-screen B. The number of the main screen and sub-screens is not limited to one.

The user interface part 110 comprises a user manipulator 112 included in the digital broadcasting apparatus 100 or a remote controller 114 which outputs an infrared signal. Accordingly, if the remote controller 114 and digital broadcasting apparatus 100 are not manufactured by the same company, the user may request an operation according to the exemplary embodiment of the present invention using the user manipulator 112.

The signal receiver 120 receives a key signal emitted from the user manipulator 112 or the remote controller 114 of the user interface part 110, and outputs the signal to the monitor application part 130.

The monitor application part 130 controls the entire operation of all applications, for example an application program (such as an Xlet), a native application or other applications, operated in the digital broadcasting apparatus 100.

Particularly, the monitor application part 130 determines whether the key signal received from the signal receiver 120 is output to the determiner 140 or the function module 150. In other words, if the PIP mode is currently activated, the monitor application part 130 may determine whether the received key signal is a first signal for controlling one of a plurality of Xlets or a second signal for controlling only a native program which is not an Xlet.

The monitor application part 130 checks a specification defined in the ACAP standard or OCAP standard to determine whether the received key signal is the first signal or the second signal. A key signal for controlling the Xlet may be defined in the ACAP standard or OCAP standard.

Accordingly, if the received key signal is defined in the ACAP standard or OCAP standard, the monitor application part 130 may determine that the received key signal is the first signal, and if the received key signal is not defined in the ACAP standard or OCAP standard, the monitor application part 130 may determine that the received key signal is the second signal. The ACAP standard or OCAP standard may be stored in a separately provided memory (not illustrated).

If the monitor application part 130 determines that the received key signal is the first signal, the monitor application part 130 may output the received signal to the determiner 140. If the monitor application part 130 determines that the received key signal is the second signal, the monitor application part 130 may output the received signal to the function module 150.

If the key signal is input from the monitor application part 130, the determiner 140 may determine whether a currently focused target screen is set to the main screen A or sub-screen B of the display part 170. Specifically, the determiner 140 checks whether the target screen set so as to reflect the received key signal is the main screen A or the sub-screen B from the storage part 160, and outputs identification information of the determined target screen to the function module 150.

Function module 150 may serve as a module to actually implement functions provided from the digital broadcasting apparatus 100, and is referred to as a native implementation part. The function module 150 comprises the native application regardless of the Java application. The native application refers to a program with the exception of the application programs including an Xlet, and may be designed in the native programming language, such as C, C+, and C++.

The native application may include, for example, an application for the PIP mode. If the PIP mode is requested through the user interface part 110, the function module 150 may process signals transmitted from two tuned channels to be displayed on the main screen A and sub-screen B.

In a situation when displaying the Xlets being received from different channels in the PIP mode, if the determiner 140 determines that the current target screen is the main screen A, the function module 150 may apply a specific function corresponding to the received key signal to the main screen A. For example, the received key signal is a signal output from a blue button requesting a temporary stop of the Xlet, the function module 150 may cause the operation of the Xlet being displayed on the main screen A to be temporarily stopped.

Additionally, in the same situation, if the determiner 140 determines that the current target screen is the sub-screen B, the function module 150 may apply a specific function corresponding to the received key signal to the sub-screen B.

The native application may further include a menu, such as a graphical user interface (GUI). Accordingly, the function module 150 comprises a GUI generator 152 which generates a GUI, as shown in FIG. 2. If a GUI generation is requested through the user interface part 110 in order to request the setting of the target screen, the GUI generator 152 may generate a GUI 200 shown in FIG. 2, and the display part 170 may display the generated GUI 200.

Referring to FIG. 2, in order to set one of the main screen A and sub-screen B as a target screen, the GUI 200 displays a preview 210 of the main screen A and sub-screen B, together with a guide message indicating “Please select a target screen to which a key signal input in a PIP mode is applied”.

If a user selects a checkbox 220 corresponding to the main screen A using the user interface part 110, and then presses an “OK” button 240, the storage part 160 may store information indicating that the main screen A is selected as a target screen that will be focused.

If a user selects a checkbox 230 corresponding to the sub-screen B using the user interface part 110, and then presses the “OK” button 240, the storage part 160 may store information indicating that the sub-screen B is selected as a target screen that will be focused. For example, if the main screen A is set as a target screen, the storage part 160 may store “1” as identification information of the target screen, and if the sub-screen B is set as a target screen, the storage part 160 may store “0” as identification information of the target screen.

The identification information of the target screen stored in the storage part 160 may be changed. Specifically, if a user requests a display of the GUI 200 through the user interface part 110, the target screen that will be focused may be changed through the displayed GUI 200.

If the PIP mode is executed, the display part 170 may display different programs on the main screen A and sub-screen B. When displaying the Xlets being received from different channels in the PIP mode, an Xlet provided from a channel set to a main screen A is displayed on the main screen A, and an Xlet provided from a channel set to a sub-screen B is displayed on the sub-screen B.

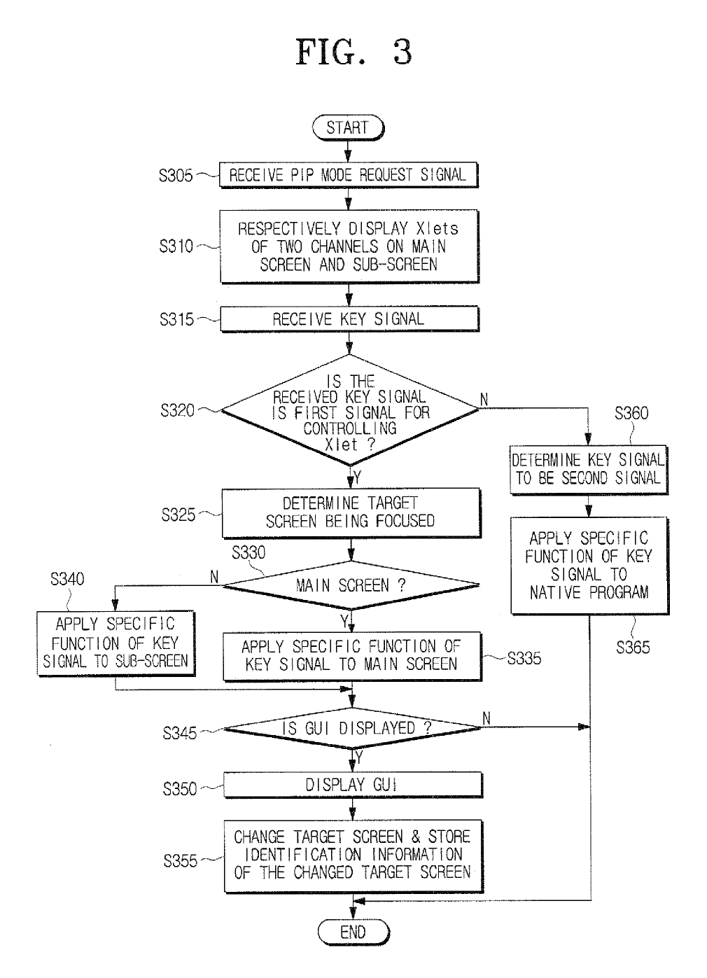

FIG. 3 is a flowchart explaining a method for processing a key signal in the digital broadcasting apparatus shown in FIG. 1 according to an exemplary embodiment of the present invention.

Referring to FIGS. 1 to 3, a signal requesting the PIP mode from the user interface part 110 is input by the signal receiver 120 in operation S305, the function module 150 may execute the PIP mode by the signal input through the monitor application part 130 in operation S3 10. Specifically, the monitor application part 130 outputs the received signal to the function module 150, since the received signal is a signal corresponding to the native application. The function module 150 displays the Xlets of two tuned channels on the main screen A and sub-screen B, respectively, to execute the PIP mode.

During operation S310, if a key signal is input through the signal receiver 120 in operation S315, the monitor application part 130 may determine whether the received key signal is the first signal for controlling the Xlet in operation S320.

If it is determined that the received key signal is the first signal in operation S320, the determiner 140 may check whether a currently focused target screen is the main screen A or the sub-screen B, using the identification information stored in the storage part 160 in operation S325. For example, if “1” as identification information is stored in the storage part 160, the determiner 140 may determine that the currently focused target screen is the main screen A, and if “0” as identification information is stored in the storage part 160, the determiner 140 may determine that the currently focused target screen is the sub-screen B.

If it is determined that the target screen is the main screen A in operation S330, the function module 150 may apply a specific function corresponding to the key signal received at operation S315 to the main screen A in operation S335. On the other hand, if it is determined that the set target screen is the sub-screen B, the function module 150 may apply a specific function corresponding to the key signal received at operation S315 to the sub-screen B in operation S340.

Next, if a signal requesting a display of a GUI 200 is input through the signal receiver 120 in order to set the target screen in operation S345, the GUI generator 152 may generate a GUI 200 for setting the target screen, as shown in FIG. 2, and the display part 170 may display the generated GUI 200 in operation S350.

If a user then changes the currently set target screen by manipulating the user interface part 110, that is, the main screen A is changed to the sub-screen B or the sub-screen B is changed to the main screen A, the storage part 160 may store identification information of the changed target screen in operation S355.

Subsequently, if a key signal is received in the same manner as in operation S315, the digital broadcasting apparatus 100 may determine the finally set target screen using the identification information stored at operation S355, and perform the above-described operations.

On the other hand, if it is determined that the received key signal is not the first signal in operation S320, the monitor application part 130 may determine that the received key signal is the second signal in operation S360. Accordingly, the function module 150 may apply a specific function corresponding to the key signal received at operation S315 to the native program in operation S365. For example, if the received key signal is a signal requesting an increase in the volume, the function module 150 may turn up the current volume.

As described above, in the digital broadcasting apparatus and method for processing the key signal according to the exemplary embodiment of the present invention, the process corresponding to the key manipulation may be suitably performed on a screen set as a target screen from among the main screen and the sub-screen when displaying different Xlets using the PIP function. This is because the user may set and change the target screen to be focused through the menu, such as a GUI. Therefore, the process corresponding to the key signal input through the user interface may be performed without errors, even if a plurality of Xlets are simultaneously executed.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A digital broadcasting apparatus for processing a key signal, the apparatus comprising:
a display part which displays application programs being received from a plurality of tuned channels on a main screen and a plurality of sub-screens;
a signal receiver which receives a key signal requesting a specific function;
a determiner which determines a target screen from among the main screen and the plurality of sub-screens, if the key signal is received; and
a function module which applies a specific function corresponding to the received key signal to the determined target screen.

2. The apparatus as claimed in claim 1, wherein the function module comprises a graphical user interface (GUI) generator which generates a GUI for setting the target screen, and
the GUI generator generates the GUI and the display part displays the generated GUI, if a display of the GUI is requested via the signal receiver.

3. The apparatus as claimed in claim 2, further comprising a storage part which stores identification information of the target screen set through the GUI,
wherein the determiner checks the identification information stored in the storage part to determine the target screen.

4. The apparatus as claimed in claim 1, wherein the target screen is changeable.

5. The apparatus as claimed in claim 1, further comprising a monitor application part which determines whether or not the received key signal is a first signal for controlling one of the application programs, if the key signal is received,
wherein the determiner determines the target screen currently being controlled, upon determination that the received key signal is the first signal.

6. The apparatus as claimed in claim 1, further comprising a monitor application part which determines whether or not the received key signal is a second signal for controlling a native program which is a non-application program, if the key signal is received,
wherein the function module applies a specific function corresponding to the received key signal to the native program, upon determination that the received key signal is the second signal.

7. The apparatus as claimed in claim 6, wherein the specific function comprises a control function related to the operation of the digital broadcasting apparatus.

8. The apparatus as claimed in claim 1, wherein the application programs are implemented in the Java programming language.

9. The apparatus as claimed in claim 1, wherein the application programs comprise an Xlet executed by a Java Application Programming Interface (API) defined in the Advanced Common Application Platform (ACAP) standard or Open Cable Application Platform (OCAP) standard.

10. The apparatus as claimed in claim 1, further comprising a user interface which generates the key signal.

11. The apparatus as claimed in claim 10, wherein the user interface comprises a user manipulator which is integrated into the digital broadcasting apparatus.

12. The apparatus as claimed in claim 10, wherein the user interface comprises a remote control which outputs an infrared signal.

13. A method for processing a key signal in a digital broadcasting apparatus, the method comprising:
displaying application programs being received from a plurality of tuned channels on a main screen and a plurality of sub-screens;
receiving a key signal requesting a specific function;
determining a target screen from among the main screen and the plurality of sub-screens; and
applying a specific function corresponding to the received key signal to the determined target screen.

14. The method as claimed in claim 13, further comprising generating and displaying a graphical user interface (GUI) if a display of the GUI for setting the target screen is requested.

15. The method as claimed in claim 14, further comprising storing identification information of the target screen set through the GUI,
wherein the determining comprises checking the stored identification information to determine the target screen.

16. The method as claimed in claim 13, wherein the target screen is changeable.

17. The method as claimed in claim 13, further comprising:
determining whether or not the received key signal is a first signal for controlling one of the application programs, if the key signal is received,
wherein the determining comprises determining the target screen currently being controlled, upon determination that the received key signal is the first signal.

18. The method as claimed in claim 13, further comprising:
determining, if the key signal is received, whether or not the received key signal is a second signal for controlling a native program which is a non-application program; and
applying a specific function corresponding to the received key signal to the native program, upon determination that the received key signal is the second signal.

19. The method as claimed in claim 18, wherein the specific function comprises a control function related to the operation of the digital broadcasting apparatus.

20. The method as claimed in claim 13, wherein the application programs are implemented in the Java programming language.

21. The method as claimed in claim 13, wherein the application programs comprise an Xlet executed by a Java Application Programming Interface (API) defined in the Advanced Common Application Platform (ACAP) standard or Open Cable Application Platform (OCAP) standard.
